(19) United States
(12) Patent Application Publication
(10) Pub. No.: US 2016/0256795 A1
(43) Pub. Date: Sep. 8, 2016

(54) HIGH TEMPERATURE PORTABLE DISTILLATION APPARATUS

(71) Applicant: Norman W. Campbell, Anaheim, CA (US)

(72) Inventor: Norman W. Campbell, Anaheim, CA (US)

(21) Appl. No.: 14/639,048

(22) Filed: Mar. 4, 2015

(51) Int. Cl. B01D 3/06

(52) U.S. Cl. CPC B01D 3/065

(57) ABSTRACT

A distillation apparatus for purifying water comprising a raw water holding chamber, a boiling chamber and a steam heating chamber, configured to allow a two-phase water purification, namely a first phase in which raw water is boiled in the boiling chamber to convert it into steam and a second phase in which the steam is superheated in the steam heating chamber to a temperature level that is at least twice the water boiling point and substantially equal to the temperature level of a heat source applied to the steam heating chamber, such that substantially all living matter from the steam is killed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to distillation apparatuses and methods and particularly to a multi-phase distillation apparatus and method.

2. Description of the Related Art

Potable water is a worldwide necessity. Where there are people and the water is undrinkable, there is a need for a way to purify the water. It is a well-known fact that through the efforts of mankind to improve life, there are sometimes unwanted consequences of our actions. This may come in the form of by-products of industry, contamination from run-off of natural resources or just blatant pollution by uncaring humans. The result is polluted water. To remove these unwanted pollutants from our drinking water, many methods have been employed, including distilling the water. There are several patents that have been issued to date that use the ancient method of distilling.

The simple “still” boils impure water, and then condenses the steam back to a usable product leaving the heavy particles in the boiling tank. This method will typically kill most living organisms and vent off inorganic compounds that boil below 212 degree F. However, some spores will live through this boiling process. To truly “purify” water of all biological substances, the temperature of the outgoing steam and vapors need to be brought above the “kill” temperature of all the living matter found in the influent.

Other technologies appear to have failed as well and/or to have serious drawbacks. For example, filters collect and concentrate impurities. Reverse-osmoses technology appear to only stops particles larger than the holes in the membrane used, and then it uses the cleaned water to flush the impurities into a run-off water system. Basic distilling vents some gases back into the atmosphere and allows some spores and other living organisms attached to the steam droplets to pass into the condensate. Processes using ultra-violet light appear to kill some or most living organisms dependent on the level and time of exposure to the light, but do not appear to address the chemicals present into the water. Chlorine based processes only addresses some or most living organisms, but not all. Cryptosporidium for example resists and can survive chlorine. Full spectrum light technology appears to only address some living organisms and chemicals that may evaporate at room temperature.

Thus, there is a need for a new and improved distillation apparatus and method that address and solve the problems outlined above

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, a multi-phase distillation apparatus is provided, one phase being a high temperature phase. This provides a unique way of abating all living matter and some minor chemical compounds with low breakdown temperatures from the raw water.

In another exemplary embodiment, the disclosed distillation apparatus is a portable distiller that raises the temperature of the steam substantially to whatever temperature the heat source reaches. This guaranties the destruction of living matter, its byproducts and some low temperature compounds as long as the heat source greatly exceeds 212 degrees F. (e.g., 451 degrees F.).

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a schematic overview of a distillation apparatus according to an embodiment.

FIG. 2 illustrates a schematic view of the filler assembly of the distillation apparatus from FIG. 1, according to an embodiment.

FIG. 3 illustrates a side view of the output tube of the distillation apparatus from FIG. 1, according to an embodiment.

FIG. 4a illustrates a sectional view of the bottom of the distillation apparatus from FIG. 1, according to an embodiment.

FIG. 4b illustrates a top view of the bottom of the distillation apparatus from FIG. 1, according to an embodiment.

FIG. 4c illustrates an exploded view of some elements of the bottom of the distillation apparatus from FIG. 1.

FIG. 5 illustrates a top view of the distillation apparatus from FIG. 1.

FIG. 6 illustrates an enlarged side view of the condenser of the distillation apparatus from FIG. 1.

FIG. 7 illustrates a sectional view of the water level indicator of the distillation apparatus from FIG. 1.

FIG. 8 illustrates a top perspective view of the distillation apparatus from FIG. 1.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled elements across the figures (e.g., 114 and 214, etc.) possess the same characteristics and are subject to the same structure and function. If there is a difference between correspondingly labeled elements that is not pointed out, and this difference results in a non-corresponding structure or function of an element for a particular embodiment, then the conflicting description given for that particular embodiment shall govern.

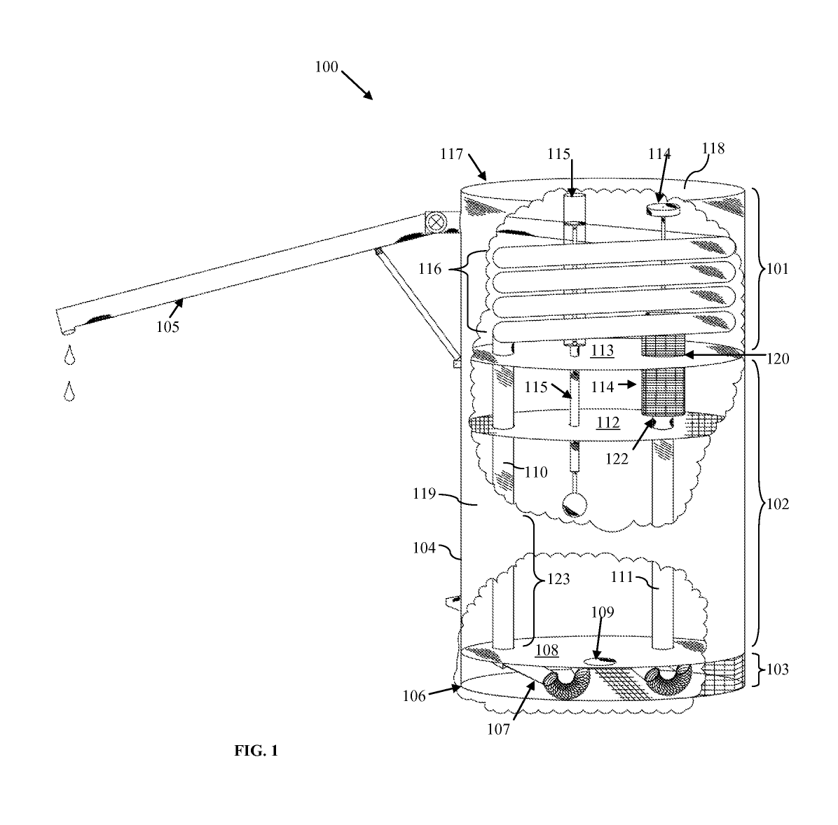

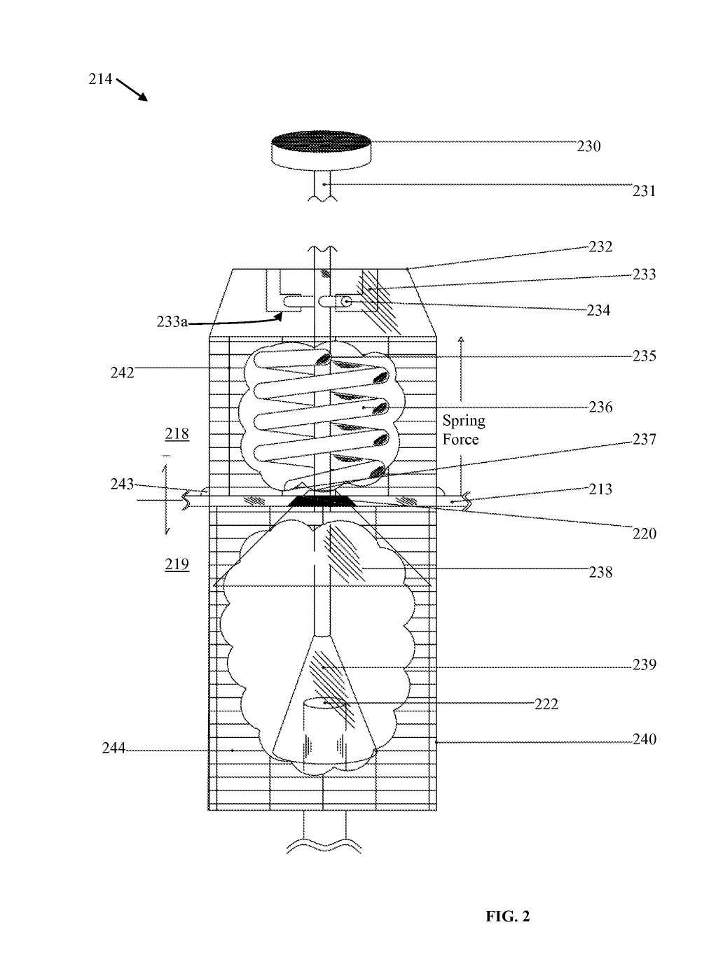

FIG. 1 illustrates a schematic overview of a distillation apparatus according to an embodiment. As shown, the distillation apparatus 100 has three major sections, 101, 102 and 103. Section 101 comprises a filling/holding tank 118 formed by the top plate 113 and the top portion of housing 104 of distiller 100. A lid or cover (not shown) may be provided at the top 117 of housing 104 to prevent dust or any other unwanted materials or substances from entering inside the housing 104. Section 101 also includes the top portion of a fill apparatus 114, which will be described in more detail when referring to FIG. 2. A top portion of a water level indicator 115 and a heat exchanger/condenser 116 is also part of section 101 of distillation apparatus 100. Each of these subsystems will be described in more detail later.

Top plate 113 is a solid plate which is sealed to housing 104, such that holding tank 118 can hold the raw water poured in by a user, and which is common to the boiling tank 119 and holding tank 118. As shown in FIG. 1, top plate 113 may have two openings to allow the sealed penetration of the heat exchanger tubing 110 and the water level sensing probe 115, and an aperture 120 to allow the controlled release of water from the holding tank 118 into the boiling tank 119, as it will be described in more detail when referring to FIG. 2.

Section 102 of the distillation apparatus 100 comprises the boiling chamber or tank 119. This is a hollow sealed tank formed by bottom plate 108, top plate 113 and the portion of housing 104 between the two plates. Preferably, the boiling tank 119 is a metal tank, and as shown, it may include an anti-foaming screen 112, a steam inlet 122 (see 222 in FIG. 2), a steam transfer tube 111, and the lower portions of water level indicator 115 and fill assembly 114. As shown, the steam transfer tube 111 passes through the anti-foaming screen 112 and then penetrates the bottom (i.e., bottom plate 108) of the boiling tank 119. It then becomes the high temperature tube portion 107. The tube reemerges through bottom plate 108 and becomes the “flash” heat exchanger portion 123. This portion of the tubing reduces the temp of the vapor back to steam temps as it will be explained later. Then the tubing penetrates the anti-foaming screen 110 and continues into portion section 101 to become condenser 116, where the temperature of the steam is further reduced to form a condensate. The bottom plate 108 may have a removable plug 109 that may be used in the scale removal process of cleaning the distillation apparatus 100.

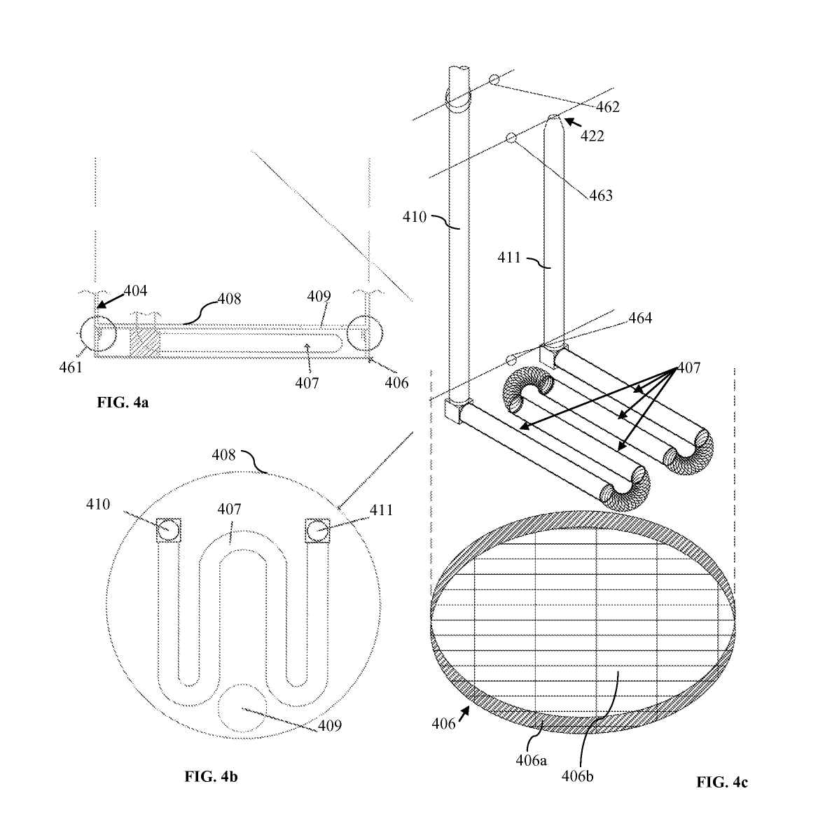

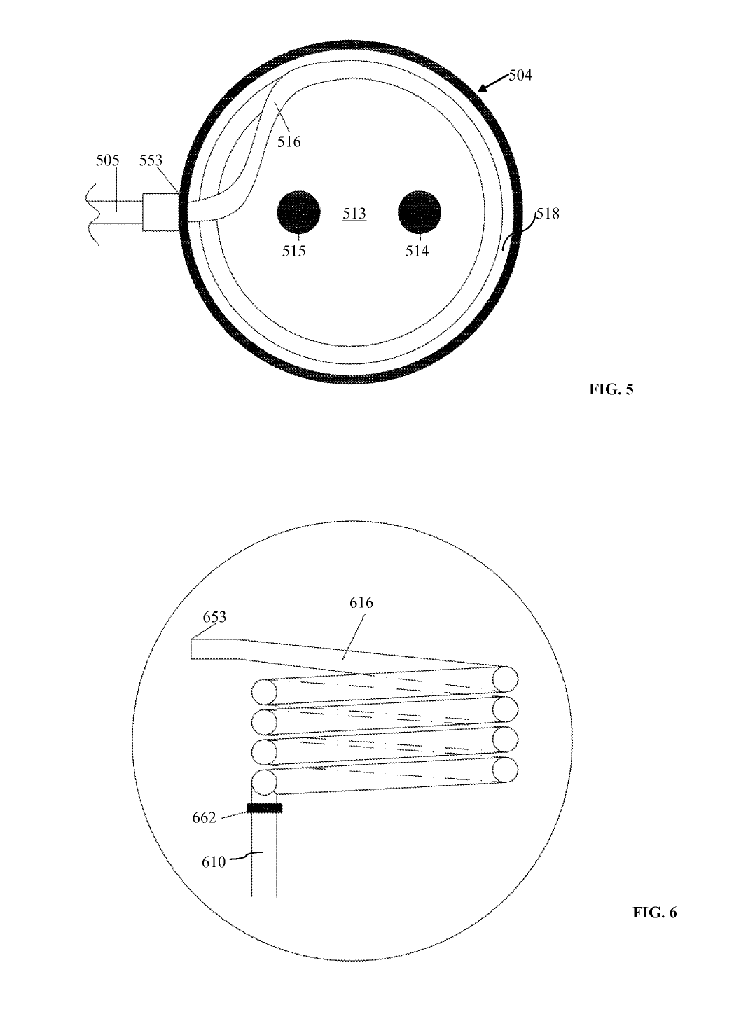

Section 103 is comprised of the solid bottom plate 108 common to the boiling tank 119, a removable perforated cover 106 (406 in FIG. 4c) and the “high temperature” portion of tubing 107. It should be noted that preferably the height of the perforated cover is greater than the diameter of the “high temperature” tubing 107, so that the heat and flames can surround the high temperature tubing 107. The perforated cover 106 protects the high temperature tubing 107 from damage while allowing the flame and heat from a heat source placed preferably under the perforated cover 106 to reach the high temperature tubing 107. The perforated cover 106 is removable for cleaning purposes.

As shown in FIG. 1, the distillation apparatus 100 has also a foldable output tube 105, which will be described in more detail when referring to FIG. 1. The output tube 105 is preferably in fluid communication with the upper end of condenser 116.

It should be noted that the housing 104 and the distillation apparatus' 100 overall appearance are shown to be round, resembling a cylindrical shape. However, it should be understood that other shapes may be adopted without departing from the scope of the invention.

FIG. 2 illustrates a schematic view of the fill assembly of the distillation apparatus from FIG. 1, according to an embodiment. The fill assembly 214 is the mechanism used to controllably fill polluted/raw water into the boiling tank 119, to be processed. The fill assembly 214 has three major purposes. First, is to hold the dirty water within the holding tank 118. Second, to let dirty water into boiling tank 119 when the fill assembly 214 is actuated by a user. The third purpose is to block dirty water from entering the high temperature tubing 107 during the cleaning process of the boiling chamber 119, as it will be described hereinafter.

As shown in FIG. 1, a portion of the fill assembly 114 is held within the upper section 101 and holding tank 118 and a portion is held within the top of section 102 and boiling chamber 119. Preferably, the fill assembly 114 is firmly attached to top plate 113, the plate separating the holding tank 118 from the boiling tank 119.

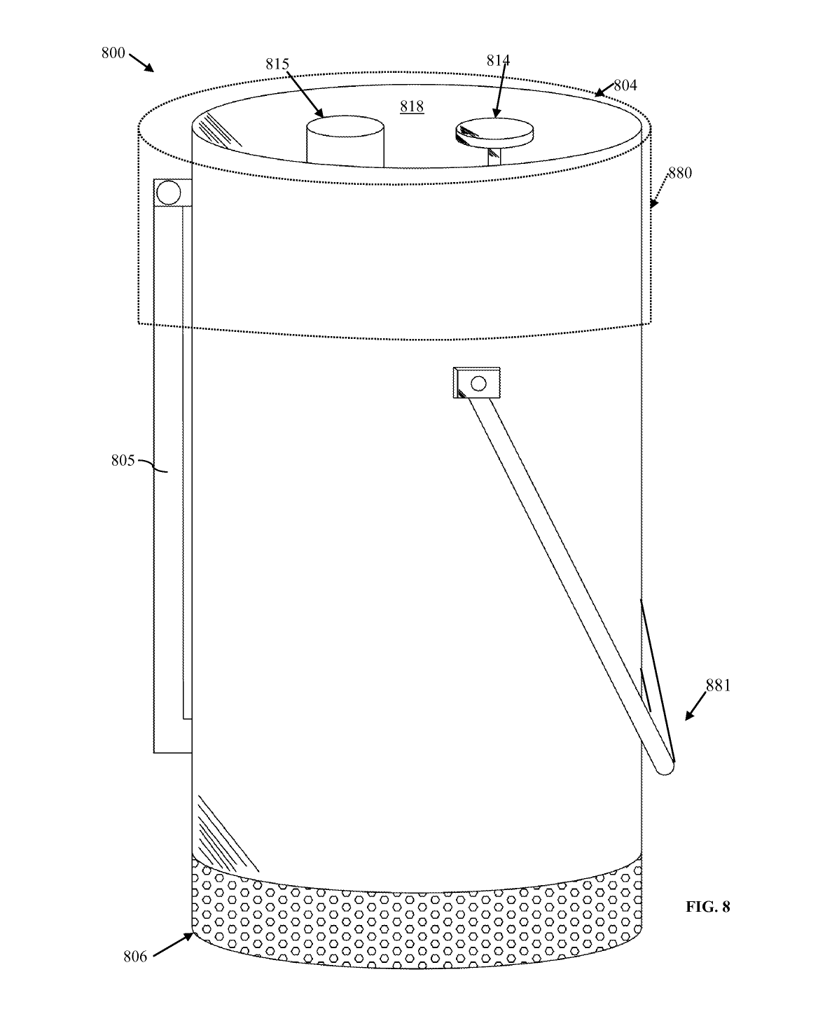

As shown, the fill assembly 214 preferably includes a spring loaded valve that when in the rest position, holds the cone 238 tightly into the hole/aperture 220 within the top plate 213, such that to prevent raw water held in holding tank 118 from entering the boiling tank 119. This blocking action also forces any pressure built up in the boiling tank 119 by the boiling action to force the steam created therein to enter into steam inlet 222. Element 230 is the top pad/button/tab, which, a user would push down to allow water from holding tank 118 to enter boiling chamber/tank 119. As shown in FIG. 1, button's 230 rest position is preferably just under the top edge of holding tank 118, to prevent breakage, and allow a removable distiller cap 880 to be placed (see FIG. 8). The distiller cap 880 may have the dual role of protecting the inside of the distillation apparatus 800 during storage or transport, and functioning as a vessel to catch pure water from output tube 805.

Button 230 may be attached to a shaft 231 as shown, which passes through a guiding vertical pathway 233, and which has a pin 234 associated with it, for locking it (i.e., the shaft) 231 in place during the cleaning process of boiling chamber 119 as will be described hereinafter. The pathway 233 is preferably provided by the top portion 232 of the main structure 240, which is preferably a rigid open framework structure allowing top portion 232 to be attached to it. When a user pushes down button 230, such that pin 234 reaches the bottom 233a of pathway 233, a slight twist of button 230 will place pin 234 into a locked position, preventing shaft 231 to travel back, upward. This temporary locked position may be used during the cleaning process of boiling chamber 119/219, as cone 239 seals steam inlet 222 when shaft 231 is pushed down and locked as described above, thus preventing cleaning solution, deposits, and so on, from entering steam inlet 222.

A top screen 242 may be placed as shown above the top plate 213 and preferably around the corresponding portion of the open frame 240. The top screen 242 is preferably configured to keep larger solid particles from the raw/dirty water of holding tank 118/218 from reaching and passing through aperture 220 into boiling chamber 119/219.

Spring 236 is preferably attached to shaft 231 at point 235. The other end of the spring is preferably resting on top plate 213. Preferably, the spring 236 is normally in a partially compressed condition, forcing shaft 231 upward. This pressure holds blocking top cone 238 tightly into hole 220 located in plate 213. Again, this action keeps dirty water from entering boiling chamber 119/219 until needed.

It should be noted that as shown in FIG. 2, top/first cone 238 is preferably of sufficient size as to cover the second/lower cone 239. This first larger size cone 238 forces the dirty water entering the boiling chamber 119 to flow past a second smaller cone 239 (which as shown preferably covers steam inlet 222 to prevent also itself raw water from entering the steam inlet) with enough distance to not allow any dirty water to enter steam inlet 222 during the filling process of the boiling chamber 119.

As shown, shaft 231 continues past first cone 238 to lower cone 239. Both cones are preferably firmly attached to shaft 231. Lower/bottom cone 239 also acts as another obstruction to foam entering the steam inlet, besides sealing inlet 222 when shaft 231 is pushed down and locked, as described above, during the cleaning process of boiling chamber 119.

A lower screen 244 may be placed as shown below the top plate 213 and preferably around the corresponding portion of the open frame 240. The lower screen 244 is preferably configured to act as a secondary anti-foaming screen and as shown it may encompass both cones 238 and 239.

Element 243 in FIG. 2 shows a weld bead attachment, which may be used to hold fill assembly 214 firmly fastened to plate 213.

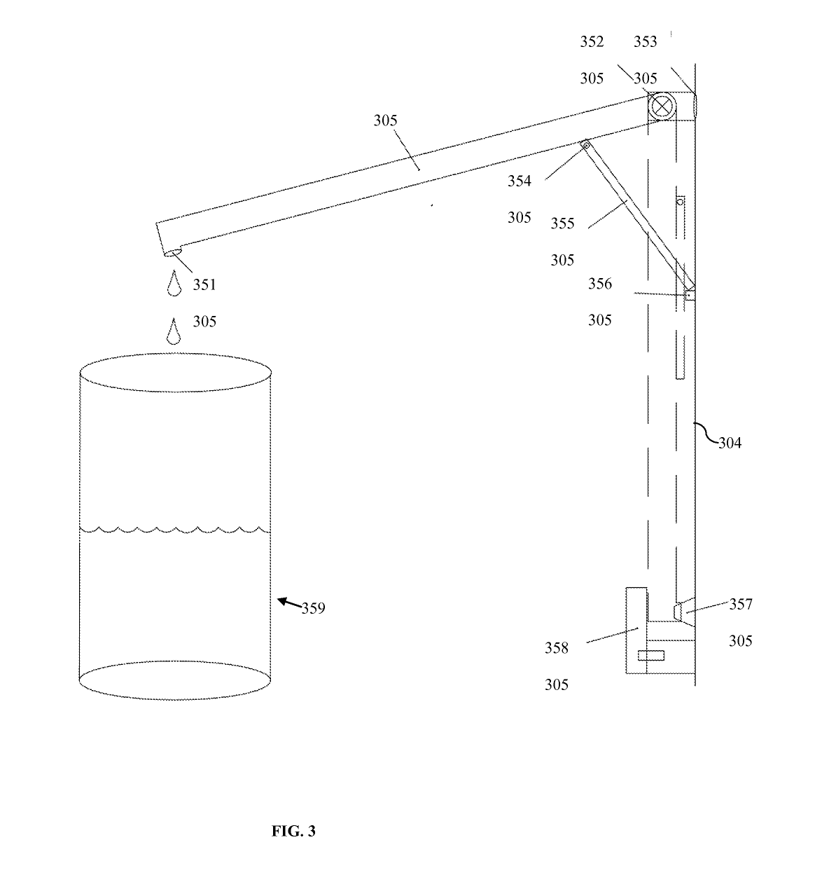

FIG. 3 illustrates a side view of the output tube of the distillation apparatus from FIG. 1, according to an embodiment. The output tube/hose/conduit 305 is in fluid communication with the condenser 116 (FIG. 1), and thus, is the final condensing tube and pour spout for the condensate. In an example, as shown in FIG. 3, a flexible joint 352 (e.g., a hinge, a rubber tube segment, etc.) may be provided just after the output tube 305 has exited the housing 304 at 353. This is so that the output tube 305 can be stored easily, as shown in broken lines in FIG. 3, alongside the housing 304 (104 in FIG. 1), for easy transport or storage. A resting arm 355 that may be also hinged at 354 may be also provided. The loose lower end of arm 355 may rest as shown against block 356 to hold output tube 305 up high enough to place a condensate capture vessel 359 under outlet 351. A small cone type plug 357 may also be provided, where outlet 351 will rest when output tube 305 is in its stored position (see broken lines). The plug 357 may be configured to seal outlet 351 so that no dirt or debris will enter the outlet during storage or during the cleaning process. Element 358 is a latching device that may be provided to hold the output tube 305 and its outlet 351 tightly against cone 357.

FIG. 4a illustrates a sectional view of the bottom of the distillation apparatus from FIG. 1, according to an embodiment. FIG. 4b illustrates a top view of the bottom of the distillation apparatus from FIG. 1, according to an embodiment. FIG. 4c illustrates an exploded view of some elements of the bottom of the distillation apparatus from FIG. 1. It should be noted that the removable perforated cover 406 is shown with a spiral or screw threading (see 461 in FIG. 4a) to removably attach to the housing 404. Any other suitable removable attachment methods may be used, such as snap-on or the like.

As stated earlier, the vertical wall 406a and/or the bottom 406b of the removable perforated cover 406 (see FIG. 4c) are perforated or have a net like structure as shown, to allow the heat and/or flames from the heat source (no shown) placed preferably under the removable perforated cover 406 to reach the high heat tube 407. The removable perforated cover 406 may be made from stainless steel or other suitable materials. The high heat/temperature tube 407 as shown may have a serpentine-like shape and may be for example a stainless tube bent to acquire the desired shape.

As shown, the high temperature tube 407 communicates at one end with the steam transfer tube 411 and steam inlet 422, and at the other end with the heat exchanger tubing 410 and further with the condenser 116 and output tube 105 (see FIG. 1).

It should be noted again that the level of penetration 464 of the heat exchanger tubing 410 and the steam transfer tube 411 through bottom plate 408 is preferably higher than the top of the high temperature tubing 407 (see FIG. 4a). This is important, as stated earlier, so that the heat and/or flames can surround the high temperature tubing 407 and thus facilitate efficient heat transfer to the high temperature tubing 407. Again, the goal is to heat up the steam to high temperature level that meets the need to separate, destroy and/or eliminate contaminants (e.g., 213-500 F for biological contaminants or 500-3,000 F for chemical contaminants). Preferably, the high temperature tubing 407 is made from materials having high thermal conductivity (e.g. stainless steel), to allow efficient heat transfer from the heat source to the steam.

It should be noted as well (see FIG. 4c) that the top level 463 of the steam transfer tube 411 and steam inlet 422 is preferably lower than the top plate 113 (FIG. 1) and the penetration level 462 of the heat exchanger tube 410 through top plate 113. This is important for allowing the steam generated in the boiling chamber 119 to enter through steam inlet 422 into steam transfer tube 411.

FIG. 5 illustrates a top view of the distillation apparatus from FIG. 1. FIG. 6 illustrates an enlarged side view of the (second) condenser of the distillation apparatus from FIG. 1. As shown, the top plate 513 and the top portion of housing 504 form the raw water tank 518. As described earlier when referring to FIG. 1, inside the raw water tank 518 reside the top portions of the water level indicator 515 and fill assembly 514 and the condenser 516 which exits the housing 504 at 553 and communicates with the output tube 505. The condenser 516 (616 in FIG. 6) may be, as shown, a coiled tube made from stainless steel or other suitable materials. Its purpose is to condense the heated steam ascending through heat exchanger tubing 610 by transferring the heat of the steam to the raw water held by the holding tank 518. By doing so, it should be observed that the condenser 516/616 also acts as a preheater/heat exchanger that preheats the raw water from the holding tank 518 before entering the boiling tank 119 (FIG. 1). Thus, energy may be saved by this preferred configuration of the distillation apparatus 100 permitting this dual function of the condenser 516/616. It should be noted in FIG. 6 also the approximate top plate penetration point 662 of the heat exchanger tubing 610 and the approximate exit point 653 of the condenser 616 from the housing 504 (FIG. 5).

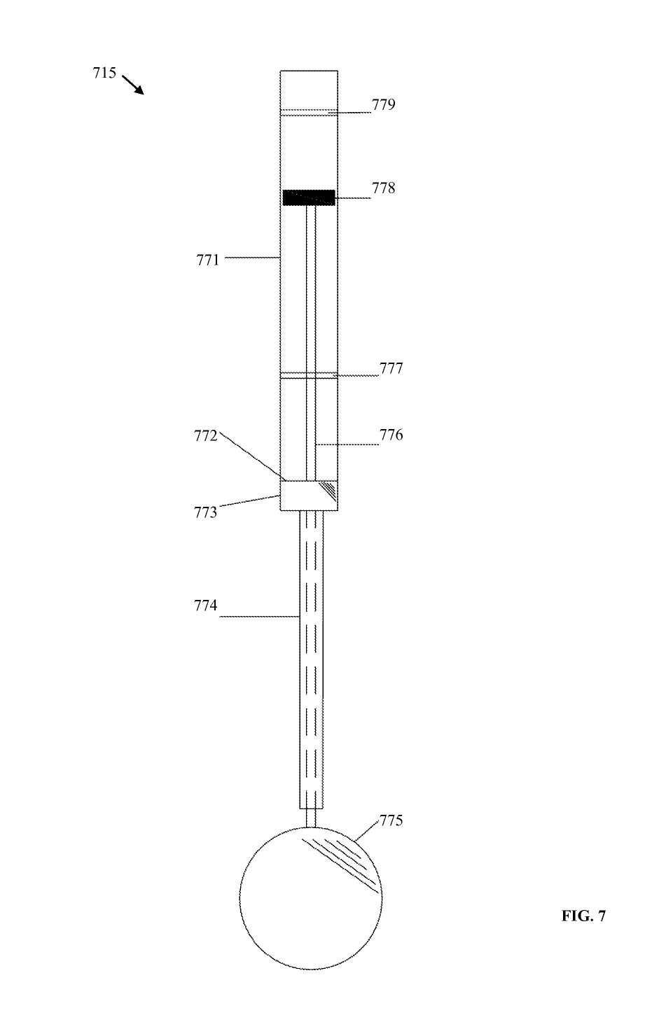

FIG. 7 illustrates a sectional view of the water level indicator assembly of the distillation apparatus from FIG. 1. The water level indicator 715 (115 in FIG. 1) may be used to monitor the water level in the boiling tank 119. It may consist of a semi sealed (open only at the bottom) preferably glass viewing tube 771, which has an upper level indication mark 779 and a lower indication mark 777. Element 772 may be a metal portion that the glass tube is fitted to and which may be used to attach the water level indicator 715 to the top plate 113. Element 773 is the approximate attachment point of element 772 to the top plate 113. Element 774 is an outer tube that protects and guides shaft 776. Shaft 776 may be attached to a float ball 775 at the bottom and level indicator 778 at the top. Based on the level of water in the boiling tank 119 (see FIG. 1), the float ball 775 pushes shaft 776 up or down and the level indicator 778 gives a visible representation when to stop adding water to tank 119 (i.e., at 779) or when to add water (i.e., at 777) to tank 119 using the fill assembly 114 as described earlier when referring to FIGS. 1-2. After adding sufficient water to boiling tank 119, a user may replenish the water in the holding tank 118 to continue the process. If enough water had been purified, a user may either let tank 119 boil dry or remove the device from the heat source.

FIG. 8 illustrates a top perspective view of the distillation apparatus from FIG. 1. The following structural elements of the distillation apparatus 800 are depicted in FIG. 8: housing 804, removable bottom cover 806, distiller cap 880, output tube 805, distiller handle 881, water level indicator assembly (top portion) 815, fill assembly (top portion) 814 and top of holding tank 818. These elements were described in detail earlier when referring to FIGS. 1-7.

### The Process of Distilling Water Using the Disclosed Apparatus

To purify water, such as when on a camping trip, a user would typically start by filling with raw water the raw water holding tank 118 (see FIG. 1). Next, the user would allow raw water from holding tank 118 to pass through the hole 120 in the bottom of the tank into boiling tank 119 using the fill assembly 114, as described earlier when referring to FIG. 2. Next, the user would typically place the distillation apparatus onto or near a heat source, such as a wood burning fire. Again, it is preferred that the bottom of the distillation apparatus 100 be placed onto or as closed as possible to the heat source so that the high temperature tube 107 reach temperatures that are as closed as possible to the temperature of the heat source.

When the water in the boiling tank 119 is heated sufficiently, to reach the boiling point, the water turns into steam and the steam is pushed by the pressure buildup into steam outlet 122/222/422 and down into the high temperature section 107/407 of the tubing below the boiling tank 119 and bottom plate 108/408, where the applied heat is its highest (i.e., very close or equal to the temperature of the heat source). This elevated heat raises the temperature of the steam from tube 107/407 above the boiling point of 212 degrees Fahrenheit (F) and breaks the steam droplets into vapor. No living entity can survive these high temperatures (e.g., at least 451 degrees F. in wood fire) and is thus killed.

Once the vapor passes through the bottom section of tubing (i.e., high heat tubing 107/407), it then ascends through the heat exchange tube 110/410 into the boiling tank 119, where, because of lower temperature (i.e., approx. 212 F), the vapor is flash cooled back into steam in the flash heat exchanger portion 123. This portion of the tubing reduces the temperature of the vapor back to steam temperature. Some (first) condensation may also occur herein. This flash cooling also aides in the boiling process of the water in boiling tank 119. The steam then travels upward into the cooling/condensing portion of tubing 116/516/616 held within the raw water tank 118/518. Again, this action will preheat the raw water before entering boiling tank 119.

Finally, the condensate leaves the condensing coils 116/516/616 and exits tank 118 and down the final cooling arm and output tube 105/305 and exits through spout 351 as clean water.

Again, when the steam from the boiling tank 119 passes through the high temperature tubing 107/407, the steam becomes a vapor and all living matter is killed. This is why this second step/phase of the water purifying process according to this disclosure is very important.

It should be understood that the temperature of the vapor in the high temperature tubing 107/407 is dependent on the heat source. A wood fire for example will exceed a minimum of 451 degrees F. According to Wikipedia, the following are the flame temperatures of common gases and fuels:

| Gas/Fuels | Flame temperature |
|---|---|
| Propane in air | 1980° C. |
| Butane in air | 1970° C. |
| Wood in air (normally not reached in a wood stove) | 1980° C. |
| Acetylene in air | 2550° C. |
| Methane (natural gas) in air | 1950° C. |
| Hydrogen in air | 2111° C. |
| Propane with oxygen | 2800° C. |
| Acetylene in oxygen | 3100° C.+ |

While these appear to be temperatures measured in a laboratory setting, the point is that the distillation apparatus disclosed herein is configured to allow the water vapors to reach same or near the same temperatures. These are very high temperatures, which will certainly kill any living matter and break apart certain chemical compounds.

Again, the raw water is preheated (except during the first filling) before it enters the boiling chamber 119 by extracting heat that flows with the superheated steam through condenser 116. This raw water also helps to condense the clean water inside condenser 116.

### The Process of Cleaning the Distillation Apparatus

As with all distilling, scale builds up on the inside of the boiling tank 119. This scale is all of the heavy particles left behind when the water forms steam and leaves the chamber. The cleaning process of this apparatus is quite simple. It is to be done typically after the temperature of the device is cool to the touch. First, a user would typically set output tube 305 (see FIG. 3) down to the side of the tank and latch into position using latch 358. Next, a user would push tab 230 (see FIG. 2) down and twist to lock as described earlier when referring to FIG. 2. Then, the distillation apparatus would be tipped upside down to remove any standing water in the top tank 118. Next, the bottom cover 106 and plug 109 would be removed. If there is running water nearby, the user would pour a cup or so of water into the bottom through hole that 109 plugs. Next, plug 109 would be reinstalled and the apparatus would be shaken vigorously to loosen scale in tank 119. Next, plug 109 would be removed and tank 119 drained. Finally, plug 109 and cover 106 would be reinstalled.

Thus, a uniqueness of this device is the exposure of the steam to excessive temperatures to kill all living matter that may be present in the raw water. Another uniqueness is the use of the applied heat to its fullest.

Where there are people and water is undrinkable, there is a need for the disclosed apparatus and method. As in all distillers, there needs to be a heat source. The disclosed apparatus leaves that to the user of the apparatus, so that the user has a wide range of options. The apparatus is not limited to for example a cook top range burner nor a simple open fire. There is the possibility of using solar and other natural heat sources. Further, an optional electric hot plate may be incorporated into or added to the apparatus.

The disclosed distillation apparatus can be scaled based on the need. For example a small version may be sized for camping or for the survivalist. A medium version may be designed for homes and small disaster relief Other models can be scaled up to almost any size and depends only on the heat source applied.

It should be noted that the disclosed apparatus uses no electronics, although occasional human monitoring is needed to produce a constant flow of clean water. This makes the apparatus inexpensive to manufacture and easy to maintain.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A distillation apparatus for purifying water comprising three vertically stacked sections, namely a top section for receiving and holding raw water, a middle section for boiling raw water received from the top section and a bottom section for increasing the temperature of steam collected from the middle section to a level substantially equal to the temperature level of a heat source applied to the bottom section, a tube configured to collect the steam from the middle section through a steam inlet, transport the steam through the bottom section for the temperature increase, then transport the steam back into the middle section for a flash heat exchange and further into the top section holding the raw water for further heat exchange causing condensation of the steam, and a fill assembly for controlled release of raw water from the top section into the middle section, the fill assembly comprising a valve mounted into a bottom portion of the top section, which is normally closed to force steam from the middle section to enter the steam inlet, and which, when actuated by a user releases raw water into the middle section, and a bottom cone covering the steam inlet and mounted on a shaft such that to direct raw water released into the middle section away from the steam inlet, obstruct foam from entering the steam inlet and seal the steam inlet when actuated by the user.

2. The distillation apparatus of claim 1, wherein the fill assembly further comprises a top cone mounted above the bottom cone, being larger than the bottom cone and being mounted such that to direct raw water released into the middle section away from the bottom cone, thus providing an additional layer of protection for the steam inlet.

3. The distillation apparatus of claim 2, wherein the shaft is configured to be lockable such that to hold the bottom cone in a position that seals the steam inlet during cleaning of the middle section of the distillation apparatus.

4. The distillation apparatus of claim 3, wherein a first portion of the fill assembly is housed by the top section and comprises a top screen configured to prevent solid particles from the raw water from entering the middle section, and wherein a second portion of the fill assembly comprising the top and bottom cones is housed by the middle section and comprises an anti-foaming screen.

5. The distillation apparatus of claim 1, wherein the bottom section comprises a perforated cover allowing flames from the heat source to reach a portion of the tube housed by the bottom section.

6. The distillation apparatus of claim 5, wherein the bottom section has a height that is greater than the diameter of the tube so that the heat from the heat source can surround the portion of the tube housed by the bottom section and thus facilitate efficient heat transfer.

7. The distillation apparatus of claim 1, further comprising a foldable output conduit which is in fluid communication with a portion of the tube housed by the top section.

8. The distillation apparatus of claim 1, wherein, in the bottom section, the temperature of the steam is increased to a level that is at least twice that of water's boiling point.

9. The distillation apparatus of claim 1, wherein, in the bottom section, the temperature of the steam is increased to at least 451 degrees Fahrenheit.

10. The distillation apparatus of claim 1, further comprising a water level indicator assembly comprising a viewing tube housed by the top section and having an upper indication mark and a lower indication mark and a shaft attached at the bottom to a float ball housed by the middle section and to a level indicator housed inside the viewing tube at the top, such that the float ball pushes the shaft up or down and the level indicator gives a visible representation of the level of raw water inside the middle section.

11. A distillation apparatus for purifying water comprising a raw water holding chamber, a boiling chamber and a steam heating chamber, configured to allow a two-phase water purification, namely a first phase in which raw water is boiled in the boiling chamber to convert it into steam and a second phase in which the steam is superheated in the steam heating chamber to a temperature level that is at least twice the water boiling point and substantially equal to the temperature level of a heat source applied to the steam heating chamber, such that substantially all living matter from the steam is killed.

12. The distillation apparatus of claim 11, further comprising a condenser for converting the superheated steam into a condensate.

13. The distillation apparatus of claim 12, further comprising a fill assembly for controlled release of raw water from the holding chamber into the boiling chamber, the fill assembly comprising a valve mounted into a bottom portion of the holding chamber, which is normally closed to force steam from the boiling chamber to enter a steam inlet located inside the boiling chamber, and which, when actuated by a user, releases raw water into the boiling chamber, and a bottom cone covering the steam inlet and mounted on a shaft such that to direct raw water released into the boiling chamber away from the steam inlet, obstruct foam from entering the steam inlet and seal the steam inlet when actuated by the user.

14. The distillation apparatus of claim 13, wherein the fill assembly further comprises a top cone mounted above the bottom cone, being larger than the bottom cone and being mounted such that to direct raw water released into the boiling chamber away from the bottom cone, thus providing an additional layer of protection for the steam inlet.

15. The distillation apparatus of claim 14, wherein the shaft is configured to be lockable such that to hold the bottom cone in a position that seals the steam inlet during cleaning of the boiling chamber of the distillation apparatus.

16. The distillation apparatus of claim 15, wherein a first portion of the fill assembly is housed by the holding chamber and comprises a top screen configured to prevent solid particles from the raw water from entering the boiling chamber, and wherein a second portion of the fill assembly comprising the top and bottom cones is housed by the boiling chamber and comprises an anti-foaming screen.

17. The distillation apparatus of claim 11 wherein the steam is superheated to at least 451 degrees Fahrenheit.
